(19) United States
(12) Patent Application Publication
(10) Pub. No.: US 2018/0292907 A1
(43) Pub. Date: Oct. 11, 2018

(54) GESTURE CONTROL SYSTEM AND METHOD FOR SMART HOME

(71) Applicant: Itay KATZ, Tel Aviv (IL)

(72) Inventor: Itay KATZ, Tel Aviv (IL)

(21) Appl. No.: 15/577,693

(22) PCT Filed: May 29, 2016
(86) PCT No.: PCT/IB2016/000838

§ 371 Date: Nov. 28, 2017

Related U.S. Application Data
(60) Provisional application No. 62/167,309, filed on May 28, 2015.

(51) Int. Cl. G06F 3/01; H04L 12/28; G06F 3/16

(52) U.S. Cl. CPC G06F 3/017; G06F 3/167; H04L 12/2803; G06F 3/013

(57) ABSTRACT

Systems, devices, methods, and non-transitory computer-readable media are provided for gesture detection and gesture initiated content display. For example, a gesture recognition system is disclosed that includes at least one processor. The processor may be configured to receive at least one image. The processor may also be configured to process the at least one image to identify (a) information corresponding to a hand gesture performed by a user and (b) information corresponding to a surface. The processor may also be configured to display content associated with the identified hand gesture in relation to the surface.

### CROSS-REFERENCE TO RELATED APPLICATION

This application is related to and claims the benefit of U.S. patent application Ser. No. 62/167,309, filed May 28, 2015 which is incorporated herein by reference in its entirety.

### TECHNICAL FIELD

The present disclosure relates to the field of gesture detection and, more particularly, devices and computer-readable media for gesture initiated content display.

### BACKGROUND

Permitting a user to interact with a device or an application running on a device can be useful in many different settings. For example, keyboards, mice, and joysticks are often included with electronic systems to enable a user to input data, manipulate data, and cause a processor of the system to execute a variety of other actions. Increasingly, however, touch-based input devices, such as keyboards, mice, and joysticks, are being replaced by, or supplemented with devices that permit touch-free user interaction. For example, a system may include an image sensor to capture images of a user, including, for example, a user's hand and/or fingers. A processor may be configured to receive such images and initiate actions based on touch-free gestures performed by the user.

### SUMMARY

In one disclosed embodiment, a gesture detection system is disclosed. The gesture recognition system can include at least one processor. The processor may be configured to receive at least one image. The processor may also be configured to process the at least one image to identify (a) information corresponding to a hand gesture performed by a user and (b) information corresponding to a surface. The processor may also be configured to display content associated with the identified hand gesture in relation to the surface.

Additional aspects related to the embodiments will be set forth in part in the description which follows, and in part will be understood from the description, or may be learned by practice of the disclosed embodiments.

It is to be understood that both the foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 illustrates an example system for implementing the disclosed embodiments.

FIG. 1 illustrates an example system for implementing the disclosed embodiments.

FIG. 1 illustrates an example system for implementing the disclosed embodiments.

FIG. 2 illustrates another example system for implementing the disclosed embodiments.

FIG. 3 illustrates another example system for implementing the disclosed embodiments.

FIG. 4 illustrates another example system for implementing the disclosed embodiments.

FIG. 5 illustrates another example system for implementing the disclosed embodiments.

FIG. 6A illustrates an example implementation of the disclosed embodiments.

FIG. 6B illustrates another example implementation of the disclosed embodiments.

FIG. 7A illustrates an example method for implementing the disclosed embodiments.

FIG. 7B illustrates another example method for implementing the disclosed embodiments.

FIG. 8 illustrates another example system for implementing the disclosed embodiments.

FIG. 9 illustrates another example implementation of the disclosed embodiments.

FIG. 10 illustrates an example system for implementing the disclosed embodiments.

FIG. 11 illustrates another example implementation of the disclosed embodiments.

### DETAILED DESCRIPTION

Aspects and implementations of the present disclosure relate to data processing, and more specifically, to gesture initiated content display and enhanced gesture control using eye tracking.

Permitting a user to interact with a device or an application running on a device can be useful in many different settings. For example, keyboards, mice, and joysticks are often included with electronic systems to enable a user to input data, manipulate data, and cause a processor of the system to execute a variety of other actions. Increasingly, however, touch-based input devices, such as keyboards, mice, and joysticks, are being replaced by, or supplemented with devices that permit touch-free user interaction. For example, a system may include an image sensor to capture images of a user, including, for example, a user's hand and/or fingers. A processor may be configured to receive such images and initiate actions based on touch-free gestures performed by the user.

In today's increasingly fast-paced, high-tech society, user experience and ‘ease of activity’ have become important factors in the choices that users make when selecting devices. Touch-free interaction techniques are already well on the way to becoming available on a wide scale, and the ability to combine gestures (e.g. pointing) with other techniques (e.g., voice command and eye gaze) can further enhance the user experience.

For example, with respect to user interaction with devices such as home entertainment systems, smartphones & tablets, etc., using a combination of natural user interface methods (e.g., gesturing tracking and voice command/eye gaze) can to enable interactions such as:
Gesture/point at an album list as displayed (e.g., on a TV screen) and verbally instruct it to “play random”, add a particular album to a playlist, etc.
Gesture/point at a character in a movie and say “tell me more”
Gesture/point at a surface/area of a room (e.g., walls, tables, windows, etc.) and verbally request that a video be played/projected (or a recipe or some other content displayed, etc.) on the surface (‘point & watch’)
Gesture/point at a window and verbally request/instruct that the window, shades, etc., should be raised (e.g., by saying “raise a bit”)
Robot interactions can also be enhanced—for example, a robot can be verbally instructed to bring a device, switch off a particular light, and/or clean a certain spot on the floor.

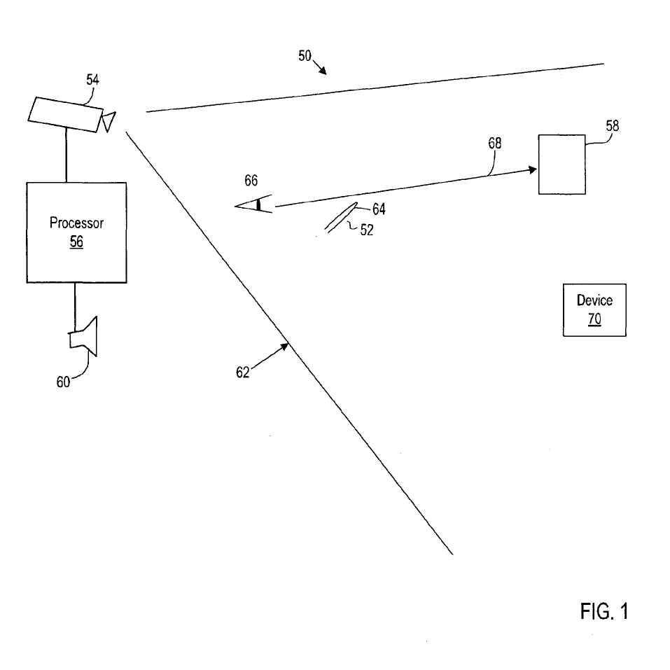

Described herein are technologies that enable the execution of commands relating to an object or image at which a pointing element is pointing. FIG. 1 shows schematically a system 50 in accordance with one implementation of the disclosed technologies. The system 50 can be configured to perceive or otherwise identify a pointing element 52 that may be for example, a finger, a wand, or stylus. The system 50 includes one or more image sensors 54 that can be configured to obtain images of a viewing space 56. Images obtained by the one or more image sensors 54 can be input or otherwise provided to a processor 56. The processor 56 can analyze the images and determine/identify the presence of an object 58, image or location in the viewing space 62 at which the pointing element 52 is pointing. The system 50 also includes one or more microphones 60 that can receive/perceive sounds (e.g., within the viewing space 62 or in the vicinity of the viewing space 62). Sounds picked-up by the one or more microphones 60 can be input/provided to the processor 56. The processor 56 analyzes the sounds picked up while the pointing element is pointing at the object, image or location, such as in order to identify the presence of one or more audio commands/messages within the picked-up sounds. The processor can then interpret the identified message and can determine or identify one or more commands associated with or related to the combination/composite of (a) the object or image at which the pointing element is pointing (as well as, in certain implementations, the type of gesture being provided) and (b) the audio command/message. The processor can then send the identified command(s) to device 70.

Accordingly, it can be appreciated that the described technologies are directed to and address specific technical challenges and longstanding deficiencies in multiple technical areas, including but not limited to image processing, real-time inspection, cargo transportation, and alerts/notifications. As described in detail herein, the disclosed technologies provide specific, technical solutions to the referenced technical challenges and unmet needs in the referenced technical fields and provide numerous advantages and improvements upon existing approaches.

It should be noted that the referenced device (as well as any other device referenced herein) may include but is not limited to any digital device, including but not limited to: a personal computer (PC), an entertainment device, set top box, television (TV), a mobile game machine, a mobile phone or tablet, e-reader, portable game console, a portable computer such as laptop or ultrabook, all-in-one, TV, connected TV, display device, a home appliance, communication device, air-condition, a docking station, a game machine, a digital camera, a watch, interactive surface, 3D display, an entertainment device, speakers, a smart home device, a kitchen appliance, a media player or media system, a location based device; and a mobile game machine, a pico projector or an embedded projector, a medical device, a medical display device, a vehicle, an in-car/in-air Infotainment system, navigation system, a wearable device, an augment reality enabled device, a wearable goggles, a location based device, a robot, interactive digital signage, digital kiosk, vending machine, an automated teller machine (ATM), and/or any other such device that can receive, output and/or process data such as the referenced commands.

It should be noted that sensor(s) 54 as depicted in FIG. 1, as well as the various other sensors depicted in other figures and described and/or referenced herein may include, for example, image sensor configured to obtain images of a three-dimensional (3-D) viewing space. The image sensor may include any image acquisition device including, for example, one or more of a camera, a light sensor, an infrared (IR) sensor, an ultrasonic sensor, a proximity sensor, a CMOS image sensor, a shortwave infrared (SWIR) image sensor, or a reflectivity sensor, a single photosensor or 1-D line sensor capable of scanning an area, a CCD image sensor, a reflectivity sensor, a depth video system comprising a 3-D image sensor or two or more two-dimensional (2-D) stereoscopic image sensors, and any other device that is capable of sensing visual characteristics of an environment. A user or pointing element situated in the viewing space of the sensor(s) may appear in images obtained by the sensor(s). The sensor(s) may output 2-D or 3-D monochrome, color, or IR video to a processing unit, which may be integrated with the sensor(s) or connected to the sensor(s) by a wired or wireless communication channel.

It should also be noted that processor 56 as depicted in FIG. 1, as well as the various other processor(s) depicted in other figures and described and/or referenced herein may include, for example, an electric circuit that performs a logic operation on an input or inputs. For example, such a processor may include one or more integrated circuits, microchips, microcontrollers, microprocessors, all or part of a central processing unit (CPU), graphics processing unit (GPU), digital signal processors (DSP), field-programmable gate array (FPGA), an application-specific integrated circuit (ASIC), or any other circuit suitable for executing instructions or performing logic operations. The at least one processor may be coincident with or may constitute any part of a processing unit such as a processing unit which may include, among other things, a processor and memory that may be used for storing images obtained by the image sensor. The processing unit may include, among other things, a processor and memory that may be used for storing images obtained by the sensor(s). The processing unit and/or the processor may be configured to execute one or more instructions that reside in the processor and/or the memory. Such a memory may include, for example, one or more of persistent memory, ROM, EEPROM, EAROM, flash memory devices, magnetic disks, magneto optical disks, CD-ROM, DVD-ROM, Blu-ray media, and may contain instructions (i.e., software or firmware) and/or other data. While in certain implementations the memory can be configured as part of the processing unit, in other implementations the memory may be external to the processing unit.

Images captured by sensor 54 may be digitized by sensor 54 and input to processor 56, or may be input to processor 56 in analog form and digitized by processor 56. Exemplary proximity sensors may include, among other things, one or more of a capacitive sensor, a capacitive displacement sensor, a laser rangefinder, a sensor that uses time-of-flight (TOF) technology, an IR sensor, a sensor that detects magnetic distortion, or any other sensor that is capable of generating information indicative of the presence of an object in proximity to the proximity sensor. In some embodiments, the information generated by a proximity sensor may include a distance of the object to the proximity sensor. A proximity sensor may be a single sensor or may be a set of sensors. Although a single sensor 54 is illustrated in FIG. 1, system 50 may include multiple types of sensors 54 and/or multiple sensors 54 of the same type. For example, multiple sensors 54 may be disposed within a single device such as a data input device housing all components of system 50, in a single device external to other components of system 50, or in various other configurations having at least one external sensor and at least one sensor built into another component (e.g., processor 56 or a display) of system 50.

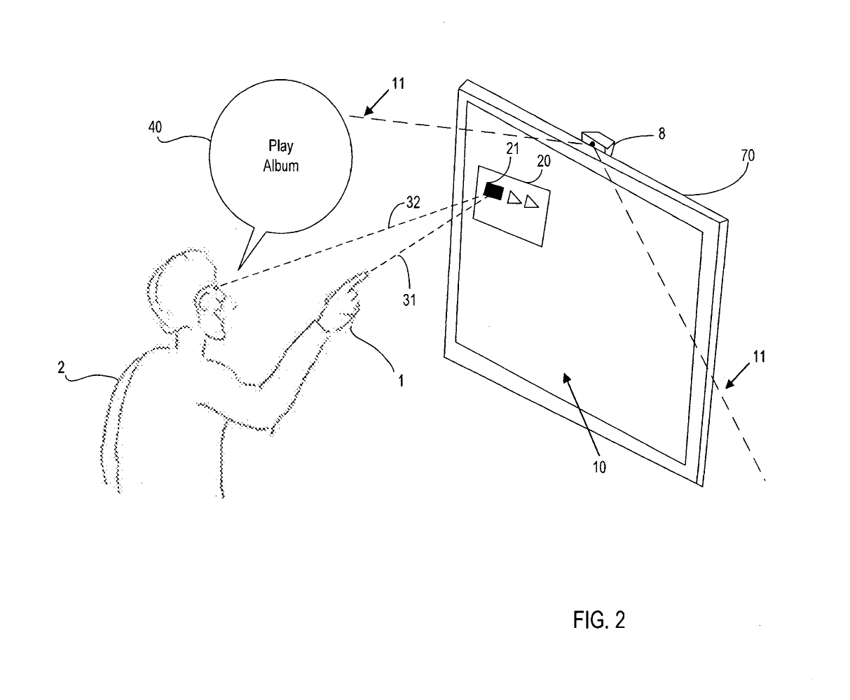

Processor 56 may be connected to sensor 54 via one or more wired or wireless communication links, and may receive data from sensor 54 such as images, or any data capable of being collected by sensor 54, such as is described herein. Such sensor data can include, for example, sensor data of a user's hand spaced a distance from the sensor and/or display (e.g., images of a user's hand and fingers 106 gesturing towards an icon or image displayed on a display device, such as is shown in FIG. 2 and described herein). Images may include one or more of an analog image captured by sensor 54, a digital image captured or determined by sensor 54, a subset of the digital or analog image captured by sensor 54, digital information further processed by processor 56, a mathematical representation or transformation of information associated with data sensed by sensor 54, information presented as visual information such as frequency data representing the image, conceptual information such as presence of objects in the field of view of the sensor. Images may also include information indicative the state of the sensor and or its parameters during capturing images e.g. exposure, frame rate, resolution of the image, color bit resolution, depth resolution, field of view of sensor 54, including information from other sensor during capturing image, e.g. proximity sensor information, accelerator information, information describing further processing that took place further to capture the image, illumination condition during capturing images, features extracted from a digital image by sensor 54, or any other information associated with sensor data sensed by sensor 54. Moreover, the referenced images may include information associated with static images, motion images (i.e., video), or any other visual-based data. In certain implementations, sensor data received from one or more sensor 54 may include motion data, GPS location coordinates and/or direction vectors, eye gaze information, sound data, and any data types measurable by various sensor types. Additionally, in certain implementations, sensor data may include metrics obtained by analyzing combinations of data from two or more sensors.

In certain implementations, processor 56 may receive data from a plurality of sensors via one or more wired or wireless communication links. Processor 56 may also be connected to a display (e.g., display device 10 as depicted in FIG. 2), and may send instructions to the display for displaying one or more images, such as those described and/or referenced herein. It should be understood that in various implementations the described, sensor(s), processor(s), and display(s) may be incorporated within a single device, or distributed across multiple devices having various combinations of the sensor(s), processor(s), and display(s).

As described and/or referenced herein, the referenced processing unit and/or processor(s) may be configured to analyze images obtained by the sensor(s) and track one or more pointing elements (e.g., pointing element 52 as shown in FIG. 1) that may be utilized by the user for interacting with a display. A pointing element may include, for example, a fingertip of a user situated in the viewing space of the sensor. In some embodiments, the pointing element may include, for example, one or more hands of the user, a part of a hand, one or more fingers, one or more parts of a finger, and one or more fingertips, or a hand-held stylus. Although various figures may depict the finger or fingertip as a pointing element, other pointing elements may be similarly used and may serve the same purpose. Thus, wherever the finger, fingertip, etc. is mentioned in the present description it should be considered as an example only and should be broadly interpreted to include other pointing elements as well.

In some embodiments, the processor is configured to cause an action associated with the detected gesture, the detected gesture location, and a relationship between the detected gesture location and the control boundary. The action performed by the processor may be, for example, generation of a message or execution of a command associated with the gesture. For example, the generated message or command may be addressed to any type of destination including, but not limited to, an operating system, one or more services, one or more applications, one or more devices, one or more remote applications, one or more remote services, or one or more remote devices. For example, the referenced processing unit/processor may be configured to present display information, such as an icon, on the display towards which the user may point his/her fingertip. The processor/processing unit may be further configured to indicate an output on the display corresponding to the location pointed at by the user.

It should be noted that, as used herein, a ‘command’ and/or ‘message’ can refer to instructions and/or content directed to and/or capable of being received/processed by any type of destination including, but not limited to, one or more of: operating system, one or more services, one or more applications, one or more devices, one or more remote applications, one or more remote services, or one or more remote devices.

It should also be understood that the various components referenced herein can be combined together or separated into further components, according to a particular implementation. Additionally, in some implementations, various components may run or be embodied on separate machines. Moreover, some operations of certain of the components are described and illustrated in more detail herein.

The presently disclosed subject matter can also be configured to enable communication with an external device or website, such as in response to a selection of a graphical (or other) element. Such communication can include sending a message to an application running on the external device, a service running on the external device, an operating system running on the external device, a process running on the external device, one or more applications running on a processor of the external device, a software program running in the background of the external device, or to one or more services running on the external device. Additionally, in certain implementations a message can be sent to an application running on the device, a service running on the device, an operating system running on the device, a process running on the device, one or more applications running on a processor of the device, a software program running in the background of the device, or to one or more services running on the device.

The presently disclosed subject matter can also include, responsive to a selection of a graphical (or other) element, sending a message requesting data relating to a graphical element identified in an image from an application running on the external device, a service running on the external device, an operating system running on the external device, a process running on the external device, one or more applications running on a processor of the external device, a software program running in the background of the external device, or to one or more services running on the external device.

The presently disclosed subject matter can also include, responsive to a selection of a graphical element, sending a message requesting a data relating to a graphical element identified in an image from an application running on the device, a service running on the device, an operating system running on the device, a process running on the device, one or more applications running on a processor of the device, a software program running in the background of the device, or to one or more services running on the device.

The message to the external device or website may be or include a command. The command may be selected for example, from a command to run an application on the external device or website, a command to stop an application running on the external device or website, a command to activate a service running on the external device or website, a command to stop a service running on the external device or website, or a command to send data relating to a graphical element identified in an image.

The message to the device may be a command. The command may be selected for example, from a command to run an application on the device, a command to stop an application running on the device or website, a command to activate a service running on the device, a command to stop a service running on the device, or a command to send data relating to a graphical element identified in an image.

The presently disclosed subject matter may further comprise, responsive to a selection of a graphical element, receiving from the external device or website data relating to a graphical element identified in an image and presenting the received data to a user. The communication with the external device or website may be over a communication network.

Commands and/or messages executed by pointing with two hands can include for example selecting an area, zooming in or out of the selected area by moving the fingertips away from or towards each other, rotation of the selected area by a rotational movement of the fingertips. A command and/or message executed by pointing with two fingers can also include creating an interaction between two objects such as combining a music track with a video track or for a gaming interaction such as selecting an object by pointing with one finger, and setting the direction of its movement by pointing to a location on the display with another finger.

The referenced commands may be executed and/or messages may be generated in response to a predefined gesture performed by the user after identification of a location on the display at which the user had been pointing. The system may be configured to detect a gesture and execute an associated command and/or generate an associated message. The detected gestures may include, for example, one or more of a swiping motion, a pinching motion of two fingers, pointing, a left to right gesture, a right to left gesture, an upwards gesture, a downwards gesture, a pushing gesture, opening a clenched fist, opening a clenched fist and moving towards the sensor(s) (also known as a “blast” gesture”), a tapping gesture, a waving gesture, a circular gesture performed by finger or hand, a clockwise and/or a counter clockwise gesture, a clapping gesture, a reverse clapping gesture, closing a hand into a fist, a pinching gesture, a reverse pinching gesture, splaying the fingers of a hand, closing together the fingers of a hand, pointing at a graphical element, holding an activating object for a predefined amount of time, clicking on a graphical element, double clicking on a graphical element, clicking on the right side of a graphical element, clicking on the left side of a graphical element, clicking on the bottom of a graphical element, clicking on the top of a graphical element, grasping an object, gesturing towards a graphical element from the right, gesturing towards a graphical element from the left, passing through a graphical element from the left, pushing an object, clapping, waving over a graphical element, a blast gesture, a clockwise or counter clockwise gesture over a graphical element, grasping a graphical element with two fingers, a click-drag-release motion, sliding an icon, and/or any other motion or pose that is detectable by a sensor.

Additionally, in certain implementations the referenced command can be a command to the remote device selected from depressing a virtual key displayed on a display device of the remote device; rotating a selection carousel; switching between desktops, running on the remote device a predefined software application; turning off an application on the remote device; turning speakers on or off; turning volume up or down; locking the remote device, unlocking the remote device, skipping to another track in a media player or between IPTV channels; controlling a navigation application; initiating a call, ending a call, presenting a notification, displaying a notification; navigating in a photo or music album gallery, scrolling web-pages, presenting an email, presenting one or more documents or maps, controlling actions in a game, pointing at a map, zooming-in or out on a map or images, painting on an image, grasping an activatable icon and pulling the activatable icon out form the display device, rotating an activatable icon, emulating touch commands on the remote device, performing one or more multi-touch commands, a touch gesture command, typing, clicking on a displayed video to pause or play, tagging a frame or capturing a frame from the video, presenting an incoming message; answering an incoming call, silencing or rejecting an incoming call, opening an incoming reminder; presenting a notification received from a network community service; presenting a notification generated by the remote device, opening a predefined application, changing the remote device from a locked mode and opening a recent call application, changing the remote device from a locked mode and opening an online service application or browser, changing the remote device from a locked mode and opening an email application, changing the remote device from locked mode and opening an online service application or browser, changing the device from a locked mode and opening a calendar application, changing the device from a locked mode and opening a reminder application, changing the device from a locked mode and opening a predefined application set by a user, set by a manufacturer of the remote device, or set by a service operator, activating an activatable icon, selecting a menu item, moving a pointer on a display, manipulating a touch free mouse, an activatable icon on a display, altering information on a display.

Moreover, in certain implementations the referenced command can be a command to the device selected from depressing a virtual key displayed on a display screen of the first device; rotating a selection carousel; switching between desktops, running on the first device a predefined software application; turning off an application on the first device; turning speakers on or off; turning volume up or down; locking the first device, unlocking the first device, skipping to another track in a media player or between IPTV channels; controlling a navigation application; initiating a call, ending a call, presenting a notification, displaying a notification; navigating in a photo or music album gallery, scrolling web-pages, presenting an email, presenting one or more documents or maps, controlling actions in a game, controlling interactive video or animated content, editing video or images, pointing at a map, zooming-in or out on a map or images, painting on an image, pushing an icon towards a display on the first device, grasping an icon and pulling the icon out form the display device, rotating an icon, emulating touch commands on the first device, performing one or more multi-touch commands, a touch gesture command, typing, clicking on a displayed video to pause or play, editing video or music commands, tagging a frame or capturing a frame from the video, cutting a subset of a video from a video, presenting an incoming message; answering an incoming call, silencing or rejecting an incoming call, opening an incoming reminder; presenting a notification received from a network community service; presenting a notification generated by the first device, opening a predefined application, changing the first device from a locked mode and opening a recent call application, changing the first device from a locked mode and opening an online service application or browser, changing the first device from a locked mode and opening an email application, changing the first device from locked mode and opening an online service application or browser, changing the device from a locked mode and opening a calendar application, changing the device from a locked mode and opening a reminder application, changing the device from a locked mode and opening a predefined application set by a user, set by a manufacturer of the first device, or set by a service operator, activating an icon, selecting a menu item, moving a pointer on a display, manipulating a touch free mouse, an icon on a display, altering information on a display.

“Movement” as used herein may include one or more of a three-dimensional path through space, speed, acceleration, angular velocity, movement path, and other known characteristics of a change in physical position or location, such as of a user's hands and/or fingers (e.g., as depicted in FIG. 2 and described herein).

“Position” as used herein may include a location within one or more dimensions in a three dimensional space, such as the X, Y, and Z axis coordinates of an object relative to the location of sensor 54. Position may also include a location or distance relative to another object detected in sensor data received from sensor 54. In some embodiments, position may also include a location of one or more hands and/or fingers relative to a user's body, indicative of a posture of the user.

“Orientation” as used herein may include an arrangement of one or more hands or one or more fingers, including a position or a direction in which the hand(s) or finger(s) are pointing. In some embodiments, an “orientation” may involve a position or direction of a detected object relative to another detected object, relative to a field of detection of sensor 54, or relative to a field of detection of the displayed device or displayed content.

A “pose” as used herein may include an arrangement of a hand and/or one or more fingers, determined at a fixed point in time and in a predetermined arrangement in which the hand and/or one or more fingers are positioned relative to one another.

A “gesture” as used herein may include a detected/recognized predefined pattern of movement detected using sensor data received from sensor 54. In some embodiments, gestures may include predefined gestures corresponding to the recognized predefined pattern of movement. The predefined gestures may involve a pattern of movement indicative of manipulating an activatable object, such as typing a keyboard key, clicking a mouse button, or moving a mouse housing. As used herein, an “activatable object” may include any displayed visual representation that, when selected or manipulated, results in data input or performance of a function. In some embodiments, a visual representation may include displayed image item or portion of a displayed image such as a keyboard image, a virtual key, a virtual button, a virtual icon, a virtual knob, a virtual switch, and a virtual slider.

In order to determine the object, image or location at which the pointing element 52 is pointing, the processor 56 may determine the location of the tip 64 of the pointing element and the location of the user's eye 66 in the viewing space 62 and extend a viewing ray 68 from the user's eye 66 through the tip 64 of the pointing element 52 until the viewing ray 68 encounters the object, location or image 58. Alternatively, the pointing may involve the pointing element 52 performing a gesture in the viewing space 62 that terminates in pointing at the object, image or location 58. In this case, the processor 56 may be configured to determine the trajectory of the pointing element in the viewing space 62 as the pointing element 52 performs the gesture. The object, image or location 58 at which the pointing element is pointing at the termination of the gesture may be determined by extrapolating/computing the trajectory towards the object, or image or location in the viewing space.

In the case that the pointing element is pointing at a graphical element on a screen, such as an icon, the graphical element, upon being identified by the processor, may be highlighted, for example, by changing the color of the graphical element, or pointing a cursor on the screen at the graphical element. The command may be directed to an application symbolized by the graphical element. In this case, the pointing may be indirect pointing using a moving cursor displayed on the screen.

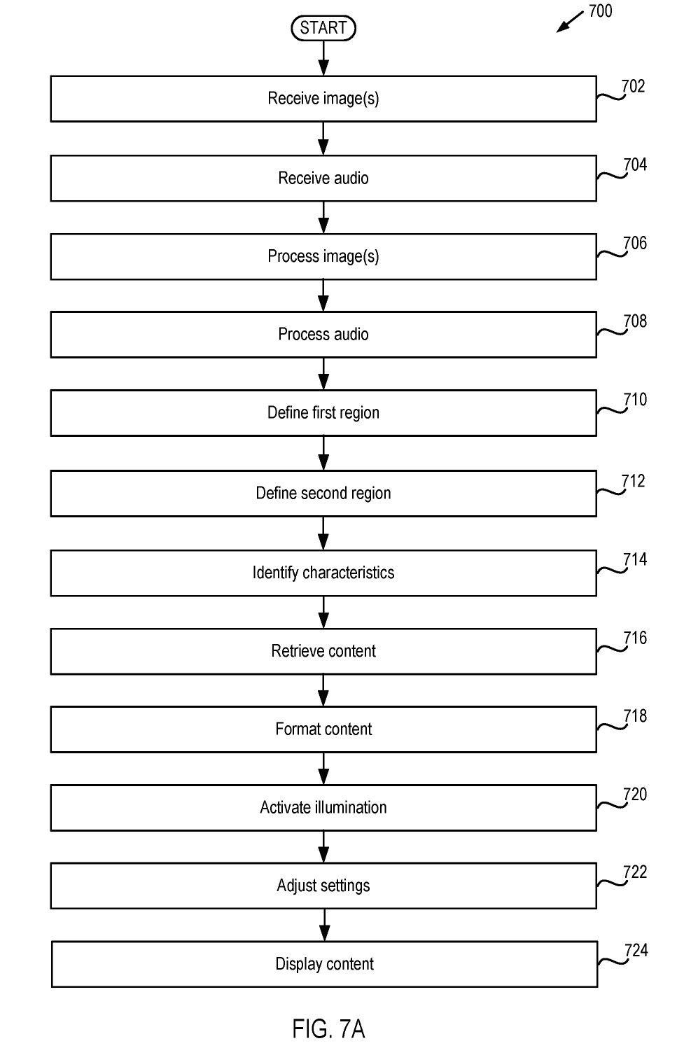

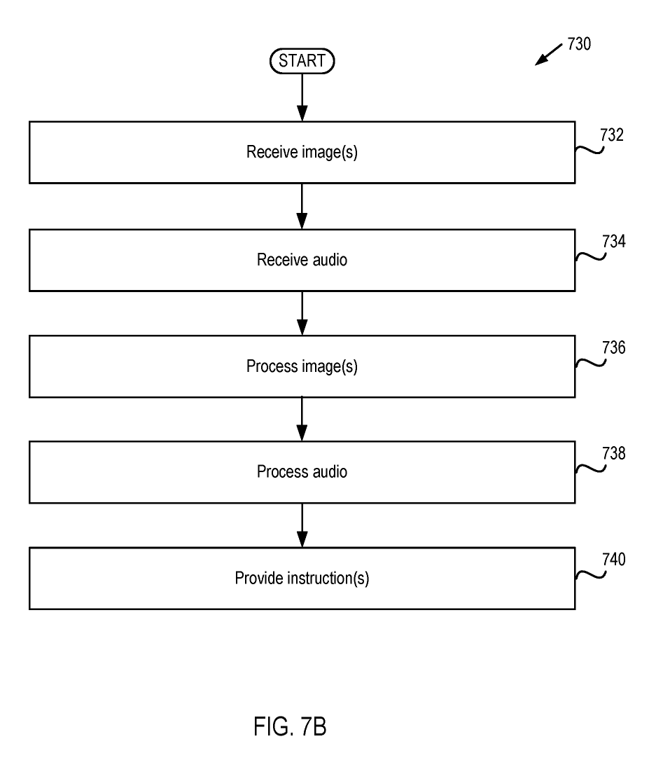

Described herein are aspects of various methods including a method/process for gesture initiated content display. Such methods are performed by processing logic that may comprise hardware (circuitry, dedicated logic, etc.), software (such as is run on a computer system or a dedicated machine), or a combination of both. In certain implementations, such methods can be performed by one or more devices, processor(s), machines, etc., including but not limited to those described and/or referenced herein. Various aspects of an exemplary method 700 are shown in FIG. 7A and described herein. It should be understood that, in certain implementations, various operations, steps, etc., of method 700 (and/or any of the other methods/processes described and/or referenced herein) may be performed by one or more of the processors/processing devices, sensors, and/or displays described and/or referenced herein, while in other embodiments some operations/steps of method 700 may be performed other processing device(s), sensor(s), etc. Additionally, in certain implementations one or more operations/steps of the methods/processes described herein may be performed using a distributed computing system including multiple processors, such as processor 56 performing at least one step of method 700, and another processor in a networked device such as a mobile phone performing at least one step of method 700. Furthermore, in some embodiments one or more steps of the described methods/processes may be performed using a cloud computing system.

For simplicity of explanation, methods are depicted and described as a series of acts. However, acts in accordance with this disclosure can occur in various orders and/or concurrently, and with other acts not presented and described herein. Furthermore, not all described/illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At step 702, a processor (e.g., processor 56) can receive at least one image, such as an image captured by sensor 54, such as in a manner described herein. At step 704, a processor (e.g., processor 56) can receive one or more audio signals (or other such audio content) such as may be captured or otherwise perceived by microphone 60. At step 706, a processor (e.g., processor 56) can process the at least one image (such as the image(s) received at 702). In doing so, information corresponding to a hand gesture performed by a user can be identified. Additionally, in certain implementations information corresponding to a surface can be identified, such as is described herein (it should be understood that, in certain implementations the referenced ‘surface’ can correspond to a wall, screen, etc., while in other implementations the referenced ‘surface’ can correspond to a display, monitor, etc., such as is described herein). At step 708, a processor (e.g., processor 56) can process the audio signals (such as the audio signal(s) received at 704). In doing so, a command, such as a predefined voice command can be identified, such as in a manner described herein. At step 724, a processor (e.g., processor 56) can display content such as audio and/or video content. In certain implementations, such content can be content associated with the identified hand gesture and/or the identified voice command. Moreover, in certain implementations the referenced content can be content identified, received, formatted, etc., in relation of the referenced surface, such as is described herein.

By way of illustration, the described technologies can enable a user to interact with a computer system. As shown in FIG. 2, the device 70 may be a computer system that includes a display device 10 and an image sensor 8 mounted on the display device 10. A user 2 may point at a location 20 on the display device 10 and utter a voice command which may relate, reference, and/or be addressed to an image displayed on the display device 10, such as in relation to the location on the display at which the user is pointing. For example, several music albums may be represented by icons 21 presented on the display device 10. The user 2 can point with a pointing element such as finger 1 at one of the icons and say “play album,” and, upon identifying the referenced hand gesture within image(s) captured by the sensor 8 and the voice command within the perceived audio signals (as described herein), the processor 56 then sends a command to the device 70 corresponding to the verbal instruction. In this example, the pointing may be direct pointing using a pointing element, or may be indirect pointing that utilizes a cursor displayed on the display device 10.

As another example, a user may pause a movie/video and/or point at a car displayed on a screen and say “tell me more.” In response, various information can be retrieved (e.g., from a third-party source) and displayed, as described in greater detail below.

Additionally, in certain implementations the described technologies can be implemented with respect to home automation devices. For example, the described technologies can be configured with respect to an automatic and/or motorized window-opening device such that when a user points at a window and says, for example, “a bit more open,” (and upon identifying the referenced hand gesture(s) and voice command(s), such as in a manner described herein), one or more corresponding instruction(s) can be provided and/or one or more actions can be initiated (e.g., to open the referenced window).

It should be noted that display 10 as depicted in FIG. 2, as well as the various other displays depicted in other figures and described and/or referenced herein may include, for example, any plane, surface, or other instrumentality capable of causing a display of images or other visual information. Further, the display may include any type of projector that projects images or visual information onto a plane or surface. For example, the display may include one or more of a television set, computer monitor, head-mounted display, broadcast reference monitor, a liquid crystal display (LCD) screen, a light-emitting diode (LED) based display, an LED-backlit LCD display, a cathode ray tube (CRT) display, an electroluminescent (ELD) display, an electronic paper/ink display, a plasma display panel, an organic light-emitting diode (OLED) display, thin-film transistor display (TFT), High-Performance Addressing display (HPA), a surface-conduction electron-emitter display, a quantum dot display, an interferometric modulator display, a swept-volume display, a carbon nanotube display, a variforcal mirror display, an emissive volume display, a laser display, a holographic display, a light field display, a wall, a three-dimensional display, an e-ink display, and any other electronic device for outputting visual information. The display may include or be part of a touch screen. FIG. 2 depicts display 10 as part of device 70. However, in alternative embodiments, display 10 may be external to device 70.

The system may also include (or receive information from) image sensor 8, which, in certain implementations, may be positioned adjacent to device 70 and configured to obtain images of a three-dimensional (3-D) viewing space bounded by the broken lines 11 (e.g., as depicted in FIG. 2). It should also be noted that sensor 8 as depicted in FIG. 2 can include, for example, a sensor such as sensor(s) 54 as described in detail above with respect to FIG. 1 (e.g., a camera, a light sensor, an IR sensor, a CMOS image sensor, etc.). By way of example, FIG. 2 depicts the image sensor 8 adjacent to the device 70, but in alternative embodiments, the image sensor 8 may be incorporated into the device 70 or even located away from the device 70.

For example, in certain implementations, in order to reduce data transfer from the sensor to an embedded device motherboard, processor, application processor, GPU, a processor controlled by the application processor, or any other processor, the gesture recognition system may be partially or completely integrated into the sensor. In the case where only partial integration to the sensor, ISP or sensor module takes place, image preprocessing, which extracts an object's features related to the predefined object, may be integrated as part of the sensor, ISP or sensor module. A mathematical representation of the video/image and/or the object's features may be transferred for further processing on an external CPU via dedicated wire connection or bus. In the case that the whole system is integrated into the sensor, ISP or sensor module, a message or command (including, for example, the messages and commands referenced herein) may be sent to an external CPU. Moreover, in some embodiments, if the system incorporates a stereoscopic image sensor, a depth map of the environment may be created by image preprocessing of the video/image in the 2D image sensors or image sensor ISPs and the mathematical representation of the video/image, object's features, and/or other reduced information may be further processed in an external CPU.

The processor or processing unit 56 (such as is depicted in FIG. 1) of device 70 may be configured to present display information, such as icon(s) 21 on display 10 towards which the user 2 may point the finger/fingertip 1. The processing unit may be further configured to indicate an output (e.g., an indicator) on the display 10 corresponding to the location pointed at by the user. For example, as shown in FIG. 2, the user 2 may point finger 1 at the display information (icon 21) as depicted on the display 10. In this example, the processing unit may determine that the user is pointing at icon 21 based on a determination that the user is pointing at specific coordinates on the display 10 ((x, y) or (x, y, z) in case of a 3-D display) that correspond to the icon. As described in detail above with respect to FIG. 1, the coordinates towards which the user is pointing can be determined based on the location of the finger/fingertip 1 with respect to the icon (as reflected by ray 31 as shown in FIG. 2) and, in certain implementations, based on the location of the user's eye and a determination of a viewing ray from the user's eye towards the icon (as reflected by ray 31 as shown in FIG. 2).

It should be understood that a gesturing location (such as the location of icon 21 at which the user is gesturing as depicted in FIG. 2) may be a representation such as a mathematical representation associated with a location on the display 10, which can be defined at some point by the system as the location on which the user points at. As noted, the gesturing location can include a specific coordinate on the display (x, y) or (x, y, z, in case of a 3-D display). The gesturing location can include an area or location on the display 10 (e.g., candidate plane). In addition, the gesturing location can be a defined as probability function associated with a location on the display (such as a 3-D Gaussian function). The gesturing location can be associated with a set of addition figures, which describes the quality of detection, such as probability indication of how accurate the estimation of the location on the display 10 of the gesturing location.

In case of a smart-glass, e.g., a wearable glass that include the capability to present to the user 2 digital information, the gesturing location may be defined as the location of a virtual plane, the plane on which the user perceived to see the digital information that is presented by the smart-glass display.

Display information may include static images, animated images, interactive objects (such as icons), videos, and/or any visual representation of information. Display information can be displayed by any method of display as described above and may include flat displays, curved displays, projectors, transparent displays, such as one used in wearable glasses, and/or displays that projects directly to or in directly to the user's eyes or pupils.

Indication or feedback of the pointed-at icon (e.g., icon 21 of FIG. 2) may be provided by, for example, one or more of a visual indication, an audio indication, a tactile indication, an ultrasonic indication, and a haptic indication. Displaying a visual indication may include, for example, displaying an icon on the display 10, changing an icon on the display, changing a color of an icon on the display (such as is depicted in FIG. 2), displaying an indication light, displaying highlighting, shadowing or other effect, moving an indicator on a display, providing a directional vibration indication, and/or providing an air tactile indication. A visual indicator may appear on top (or in front of) other images or video appearing on the display. A visual indicator, such as icon on the display selected by the user, may be collinear with the user's eye and the fingertip lying on a common viewing ray (or line of sight). As used herein, and for reasons described later in greater detail, the term “user's eye” is a short-hand phrase defining a location or area on the user's face associated with a line of sight. Thus, as used herein, the term “user's eye” encompasses the pupil of either eye or other eye feature, a location of the user face between the eyes, or a location on the user's face associated with at least one of the user's eyes, or some other anatomical feature on the face that might be correlated to a sight line. This notion is sometimes also referred to as a “virtual eye”.

An icon is an exemplary graphical element that may be displayed on the display 10 and selected by a user 2. In addition to icons, graphical elements may also include, for example, objects displayed within a displayed image and/or movie, text displayed on the display or within a displayed file, and objects displayed within an interactive game. Throughout this description, the terms “icon” and “graphical element” are used broadly to include any displayed information.

Another exemplary implementation of the described technologies is method 730 as shown in FIG. 7B and described herein. In certain implementations the described technologies can be configured to enable enhanced interaction with various other devices including but not limited to robots.

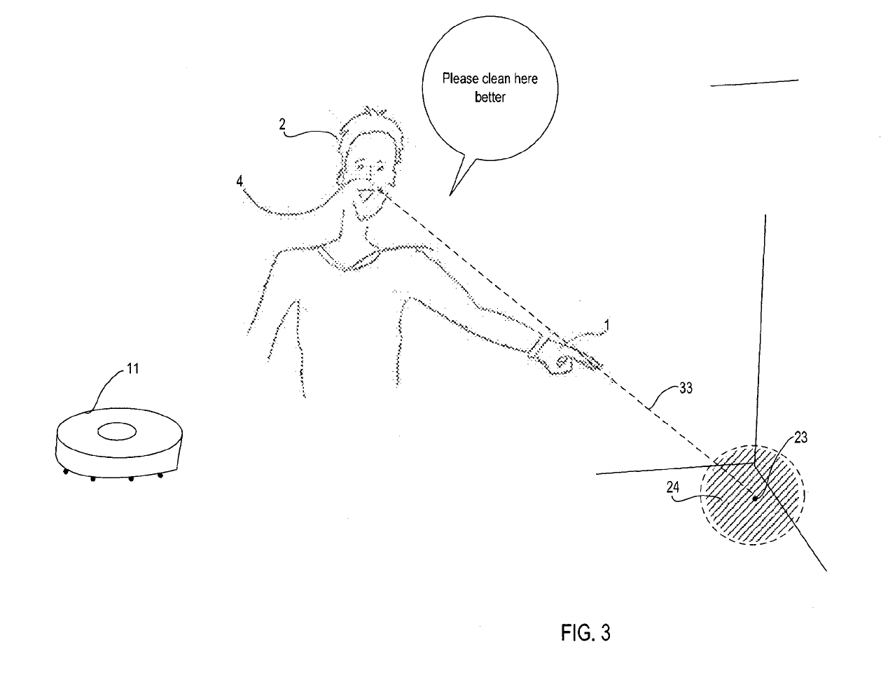

For example, the referenced device 70 may be a robot 11, as shown in FIG. 3. At step 732, a processor can receive at least one image, such as an image captured by a sensor, such as in a manner described herein. At step 734, a processor can receive one or more audio signals (or other such audio content). At step 736, a processor can process the at least one image (such as the image(s) received at 732). In doing so, information corresponding to information corresponding to a line of sight of a user directed towards a device (e.g., a robot) can be identified. Additionally, in certain implementations information corresponding to information corresponding to a hand gesture of the user (e.g., as directed towards a location) can be identified such as is described herein. At step 708, a processor can process the audio signals (such as the audio signal(s) received at 704). In doing so, a command, such as a predefined voice command can be identified, such as in a manner described herein. At step 740, a processor can provide one or more instructions to the device (e.g., the robot). In certain implementations, such instructions can correspond to the identified voice command in relation to the location, such as is described herein.

By way of illustration, as shown in FIG. 3, a user 2 points at an object and utters a verbal command to a robot 11 to perform a particular task, such as a task that relates to the object at which the user is pointing. A user may point at a location (e.g., location 23) or object in a room and say to a robot “Please clean here better/more carefully.” The user may point, for example, at a book and say “Please bring”, or point at a lamp and say “Can you close this light?” If the user can be determined to be looking at the robot when pointing at the object instead of the object, the processor 56 may recognize the line of sight 33 based on the location of the user's head 4, and determine where the user's eyes would be if he were to look at the pointing element 1, such as is described in detail herein. A corresponding command can then be provided to the device (e.g., a command to navigate robot 11 to area 24 of the room in order to perform the referenced cleaning operation(s)).

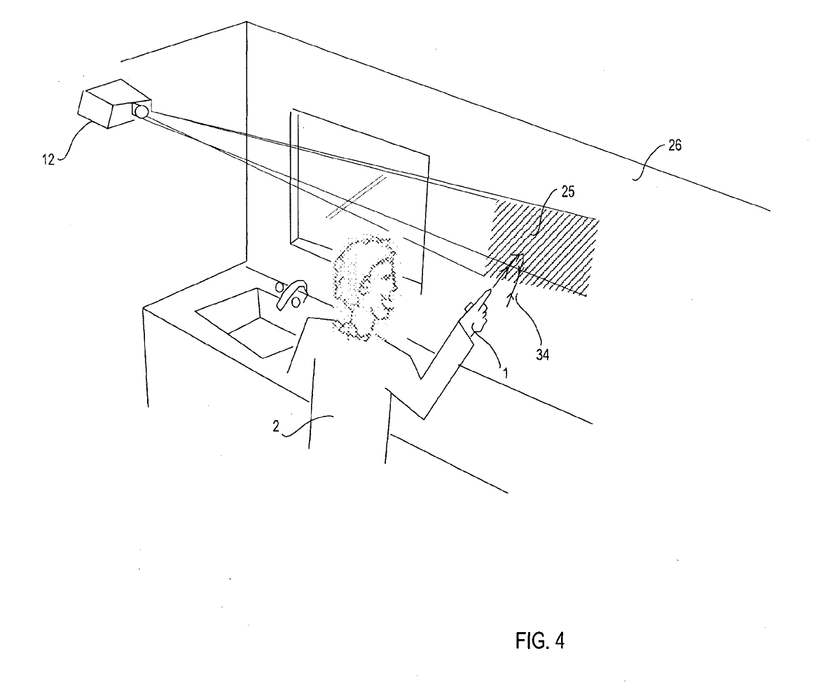

Moreover, in certain implementations the described technologies can enable the displaying of images, video, and/or other content on an object or surface. For example, as shown in FIG. 4, the pointing element (e.g., finger 1, as depicted) can point or otherwise gesture at an object or surface 26 (e.g., a wall, projector screen etc.). One or more images (or any other such visual content) of such gestures can be captured and/or otherwise received (e.g., by a camera, sensor, etc.) and can be processed in order to identify, for example, an incidence of a gesture, the presence of a particular gesture, and/or aspects of the surface. Such a gesture (e.g., a pointing gesture) can identify, for example, the surface, area, region, display screen, etc., on which the user wishes for display content (e.g., text, image, video, media, etc.) to be displayed, e.g., using the various technique(s) described herein. Additionally, in certain implementations various aspects of the eye gaze, viewing direction/ray, etc., of the user 2 can be determined (e.g., in a manner described herein) and can be utilized/accounted for in identifying the particular surface, region, etc., with respect to which the user may be requesting that content be presented on.

Concurrent/in conjunction with such gesturing, pointing, looking, gazing, etc., the user may also project or otherwise verbalize or provide a command (e.g., a verbal/audible command), such as “display [content] (e.g., a recipe, a video, etc.) here.” Accordingly, corresponding audio content/inputs (e.g., as captured by a microphone concurrent with the capture of the visual content referenced above, as described herein) can be processed (e.g., using speech recognition techniques) in order to identify one or more commands provided by the user (identifying, for example, the specific content that the user wishes to be displayed on the surface with respect to which the user is gesturing, e.g., a recipe, a video, etc.). Such content can then be retrieved (e.g., from a third-party content repository, such as a video streaming service) and displayed on/in relation to the surface identified by the user.

At step 714, a processor can process the referenced captured image(s) to identify various features, characteristics, etc., of the referenced surface. That is, it should be understood that, in certain implementations, the referenced device 70 in this case may be a projector 12 of any kind, which is configured and/or otherwise capable of projecting or otherwise displaying content, images, etc. 25 on the object or surface 26. In certain implementations, a sensor (e.g., an image sensor) can capture various inputs (e.g., images, video, etc.) of the surface the processor 56 may be configured to process such inputs to identify, determine, or otherwise extract features or characteristics of the object, surface, or area at which the user can be determined to be pointing/gesturing (e.g., the color, shape, orientation in space, reflectivity, etc. of the surface). Upon retrieving or otherwise receiving the requested content (at step 716 e.g., from a third-party content repository and as described herein), the processor may utilize the features/characteristics of the identified object in any number of ways, such as in order to compute how (e.g., with what projection settings, parameters, etc.) to format and/or project the content/image on the surface/object such that it will be perceptible to the user in a particular fashion (e.g., straight, undistorted, etc.), and may format the content accordingly, (e.g., at step 718 and as described herein). For example, if the projector is not situated directly in front of the surface/object, the processor may process the content/image in order to determine how to project the content (e.g., with what projection settings, parameters, etc.) such that the projected content appears accurately/correctly without any shear or other distortion. Additionally, in certain implementations the processor 56 may be configured to determine/measure a distance between the user 2 and the surface 26, such as in order to further determine an appropriate size with respect to which the content/image should be projected.

By way of further illustration, the referenced sensor (e.g., an image sensor) can continuously and/or periodically capture/receive inputs (e.g., images, videos, etc.) of the surface(s) on which the referenced content is being presented/projected. Such inputs can be processed and various determinations can be computed, reflecting, for example, various aspects/characteristics pertaining to the presentation of the content on the surface(s). For example, the visibility, image quality, etc., of the content being projected on the surface can be determined. It can be appreciated that various environmental conditions may change over time (e.g., amount of sunlight in the room, the direction in which the sunlight is shining, the amount of lighting in a room, etc.) and such conditions may affect various characteristics of the presentation of the content on the surface. Accordingly, by monitoring such characteristics (e.g., by processing/analyzing inputs from an image sensor which reflect the manner in which the content is being presented on the surface), it can be determined whether the content is being presented in a manner that is likely to be visible to the user 2, in view of the referenced environmental conditions, etc. Upon determining, for example, that the content has become less visible (e.g., on account of additional sunlight in the room), various parameters, settings, configurations, etc., of the projector and/or the content can be adjusted, in order to improve the visibility of the content. Additionally, as previously noted, various aspects of the content can be formatted based on determinations computed with based on inputs originating from an optical sensor which captures images, etc., of the referenced surface. For example, based on the referenced inputs, upon determining that the surface area on which the content being presented is relatively large (e.g., larger than 50 inches) and/or determining that the user is standing relatively far away from the surface (e.g., more than 3 feet away), the size of the content (e.g., font size of textual content) can be increased, in order to make the content more viewable for the user. Additionally, as noted above, characteristics of the surface can be determined and accounted for in configuring/adjusting the manner in which the content is projected/presented. For example, based on a determination that the surface is a particular color, various aspects of the content can be adjusted, e.g., to select contrasting colors for textual content in order to make it more visible when presented on the referenced surface.

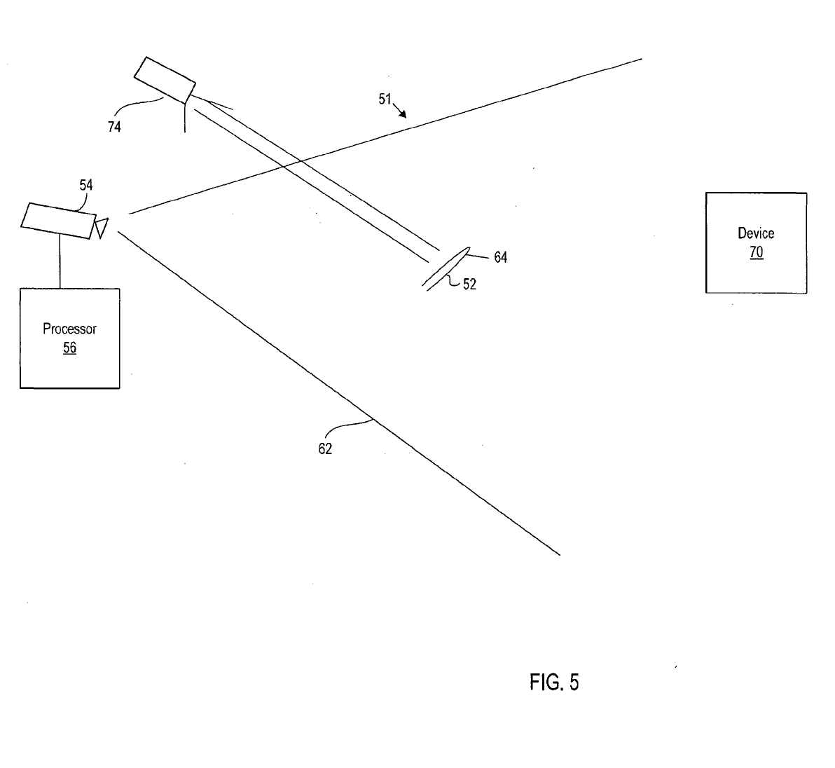

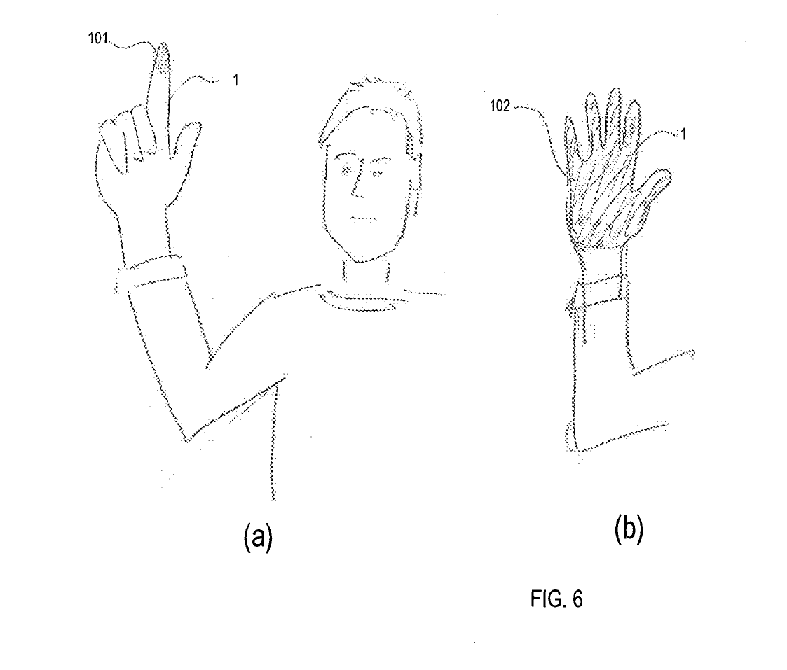

The disclosed technologies also include techniques for providing control feedback, such as in systems in which commands are generated/input to the system based on/in response to the determination/identification of gesturing, pointing, etc. using a pointing element, such as in system 51 shown schematically in FIG. 5. The system 51 can include one or more sensors 54 (e.g., image sensors) that can capture/obtain images of a viewing space/area 56. Images captured by the one or more sensors 54 can be input/provided to a processor 56. The processor 56 analyzes the image(s) and identifies/determines the location of the pointing element within/in relation to the viewing space 6, such as in a manner described herein. Upon identifying the pointing element within the image, the location of the pointing element (or a portion of the pointing element, such as the tip 64) can be identified/determined within the viewing space 62 itself. At step 720 the processor 56 then activates an illumination device 74 (which may be, for example, a projector, LED, laser, etc.). For example, in certain implementations the illumination device 74 can be activated by aiming or focusing the illumination device 74 at the pointing element 64 and illuminating a light source in order to project light towards/illuminate at least a portion of the pointing element 52. As shown in FIG. 6a, if, for example, the pointing element is a finger 1, the tip 101 of the finger 1 may be illuminated by the projector 74. Alternatively, as shown in FIG. 6b, the entire hand may be illuminated (e.g., based on a determination that the entire hand is being used as the pointing element). The illumination is preferably at least on a side of the pointing element 52 that is visible to the user. Additionally, in certain implementations various setting(s) associated with the illumination device can be adjusted, e.g., based on the identified gesture (such as at step 722). For example, the color of the illumination may be dependent on various conditions, such as the gesture the pointing element is performing. The processor 56 may be configured to identify the boundary of the pointing element in images and to confine the illumination of the pointing element within the boundary of the pointing element. The system 51 can continuously/intermittently monitor the location of the pointing element within the viewing space 62, and continuously/intermittently aim or direct illumination (as generated by the illuminating device) at the pointing element as it moves within the viewing space.

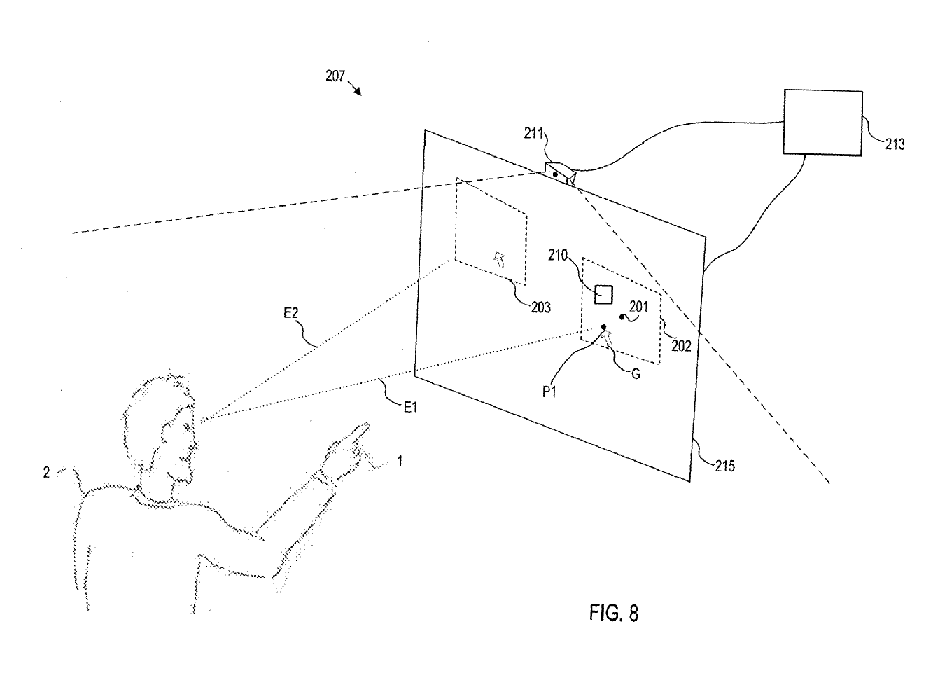

Additionally, in certain implementations the disclosed technologies provide a method and system for positioning a cursor within an interface (e.g., on a screen) and moving the cursor within such an interface. FIG. 8 shows a system 207 in accordance with one embodiment disclosed herein. The system 207 can include an image sensor 211 which can be positioned/configured to obtain images of at least a portion of a user 2, such as in order to capture both the user's eyes as well as pointing element 1 (as noted, the pointing element may be a hand, part of a hand, a finger, part of a finger, a stylus, wand, etc.) within the same image(s). Images or any other such visual content/data captured/obtained by the sensor 211 can be input/provided to and/or received by a processor 213 (e.g., at step 702 and as described herein). The processor can process/analyze such images (e.g., at step 706 and as described herein) in order to determine/identify the user's eye gaze E1 (which may reflect, for example, the angle of the gaze and/or the region of the display 215 and/or the content displayed thereon—e.g., an application, webpage, document, etc.—that the user can be determined to be directing his/her eyes at) and/or information corresponding to such an eye gaze. For example, the referenced eye gaze may be computed based on/in view of the positions of the user's pupils relative to one or more areas/landmarks on the user's face. As shown in FIG. 8, the user's eye gaze may be defined as a ray E1 extending from the user's face (e.g., towards surface/screen 215), reflecting the direction in which the user is looking.

Upon determining or otherwise identifying the referenced eye gaze, the processor can delineate or otherwise define one or more region(s) or area(s) on the screen 215 that can be determined to pertain or otherwise relate to the eye gaze (e.g., at step 710). For example, in certain implementations such a region may be a rectangle 202 having a center point 201 determined by the eye gaze and having sides or edges of particular lengths. In other implementations, such a region may be a circle (or any other shape) having a particular radius and having a center point determined by the eye gaze. It should be understood that in various implementations the region and/or its boundary may or may not be displayed or otherwise depicted on the screen (e.g., via a graphical overlay).

The processor can be further configured to display, project, or otherwise depict a cursor G on the screen/surface. The cursor may be, for example, any type of graphical element displayed on the display screen and may be static or animated. The cursor may have a pointed end P1 that is used to point at an image displayed on the screen. In certain implementations, the cursor can be displayed when the processor detects or otherwise determines the presence of the pointing element (e.g., within a defined area or zone) or the processor detects the pointing element performing a particular gesture, such as a pointing gesture (and, optionally, may be hidden at other times). Determination of the particular location/positioning of the cursor on the screen can include determining or identifying the location of a particular region 202 within the screen with respect to which the cursor is likely to be directed, and may also involve one or more gestures recently performed by/in relation to the pointing element (e.g., a pointing gesture). It should be understood that as used/referenced herein, the term “gesture” can refer to any movement of the pointing element.

Upon determining/identifying the particular region 202, the user can then move the cursor G within the region, use the cursor to interact with content within the region, etc., such as by gesturing with the pointing element. It can be appreciated that by using the direction/angle of the eye gaze of the user to direct or ‘focus’ the cursor to a particular region, the gesture(s) provided by the pointing element can be processed as being directed to that region (e.g., as opposed to other regions of the display to which such gestures might otherwise be determined to be associated with if the eye gaze of the user was not otherwise accounted for). It should be understood that any number of graphical features of the cursor, such as its color, size, or style, can be changed, whether randomly, or in response to a particular instruction, signal, etc.

At step 712, a processor can define a second region of the display. In certain implementations such a second region can be defined based on an identification of a change in the referenced eye gaze of the user. For example, upon determining that the user has changed his/her eye gaze, such as from the eye gaze E1 to the eye gaze E2 (that is, the user, for example has moved or shifted his/her gaze from one area or region of the screen/surface to another), the process described herein can be repeated in order to determine or identify a new region on the screen within which the cursor is to be directed or focused. In doing so, the cursor can be moved rapidly from the original region to the new region when the user changes his eye gaze, even without any movement of or gesturing by the pointing element. This can be advantageous, for example, in scenarios in which the user wishes to interact with another region of the screen, such a window on the opposite side of the screen from the region that the user previously interacted with. Rather than performing a broad sweeping gesture, for example (which may direct the cursor from one side of the screen to the other), by detecting the change in the user's eye gaze the cursor can be moved to the new region without necessitating any gesturing or movements of the pointing element.

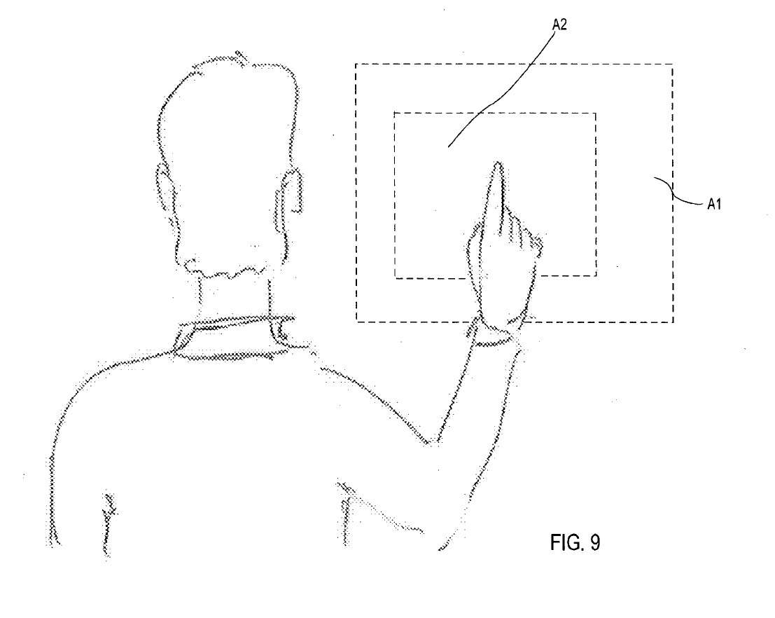

Referring now to FIG. 9, in certain implementations a first region in space, A1, can be identified/defined (e.g., by a processor) within/with respect to images (e.g., of the user) captured or obtained by the sensor/imaging device. The processor can be configured to search for/identify the presence of the pointing element within region A1, and to display, project, and/or depict the cursor (e.g., on the screen/surface) upon determining that the pointing element is present within region A1. A second region such as a sub region of A1, A2, may be further defined, such that when the pointing element is determined to be present within the space/area corresponding to A2, the movement of the cursor can be adjusted within region A2, thereby improving the resolution of the cursor.

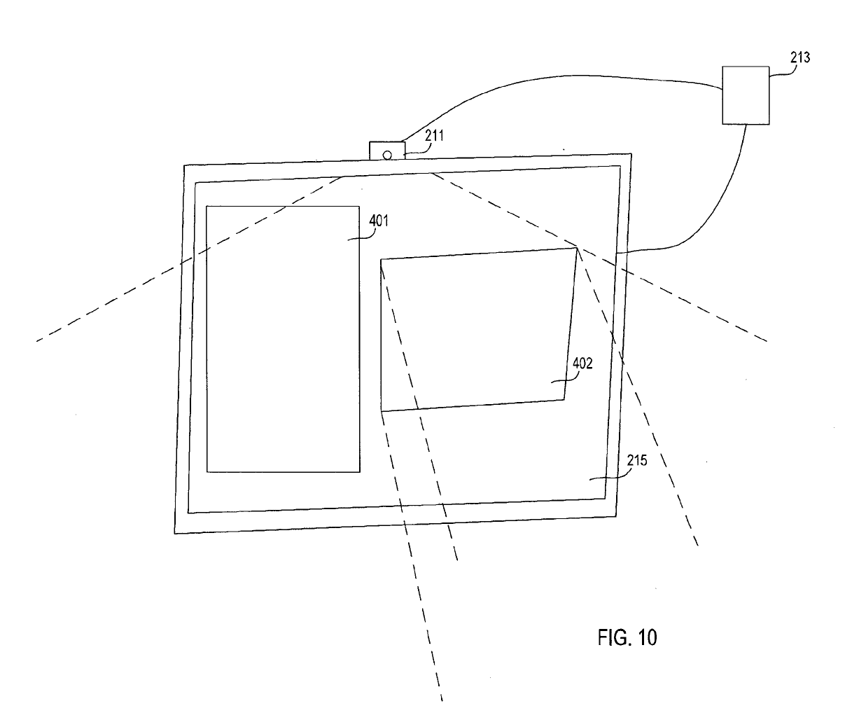

In certain implementations the described technologies can be configured to enable location based gesture interaction. For example, the disclosed technologies provide a method and system to individually/independently control multiple applications, features, etc., which may be displayed (e.g., on a display screen or any other such interface) simultaneously, such as within separate windows. In accordance with the disclosed technologies, one of the displayed applications can be selected for control by the user based on a determination that a particular gesture has been performed in a location/region associated with/corresponding to the region/area on the screen/interface that is occupied by/associated with the referenced application. For example, as shown in FIG. 10, in a scenario in which two windows 401, 402 are displayed within a single interface/screen 215, the scrolling of/navigation within one of the windows can be effected in response to a determination that the user has performed a scrolling gesture in front of the region of the screen that corresponds to that window (e.g., even while disregarding the location of the mouse cursor on the screen). In doing so, the disclosed technologies allow, for instance, the simultaneous/concurrent scrolling (or any other such navigational or other command) of two windows within the same screen/interface, without the need to select or activate one of the windows prior to scrolling within or otherwise interacting with it. Upon determining that the user has performed a scrolling motion in the area/space “in front of” a particular window, the corresponding scrolling command can be directed/sent to that application.

By way of illustration, in a scenario in which a user is facing the screen 215 as depicted in FIG. 10, commands that correspond to gestures identified as being provided by the user's left hand (which can be determined to be present in front of region 401) can be applied to/associated with region 401 (e.g., scrolling a window within the region up/down), while commands that correspond to gestures identified as being provided by the user's right hand (which can be determined to be present in front of region 402) can be applied to/associated with region 402 (e.g., scrolling a window within the region left/right). In doing so, the user can interact simultaneously with content present in multiple regions of the screen, such as by using each hand (or any other such pointing element(s)) to provide gestures that are directed to different regions.

It should also be noted that while the technologies described herein are illustrated primarily with respect to content display and gesture control, the described technologies can also be implemented in any number of additional or alternative settings or contexts and towards any number of additional objectives.

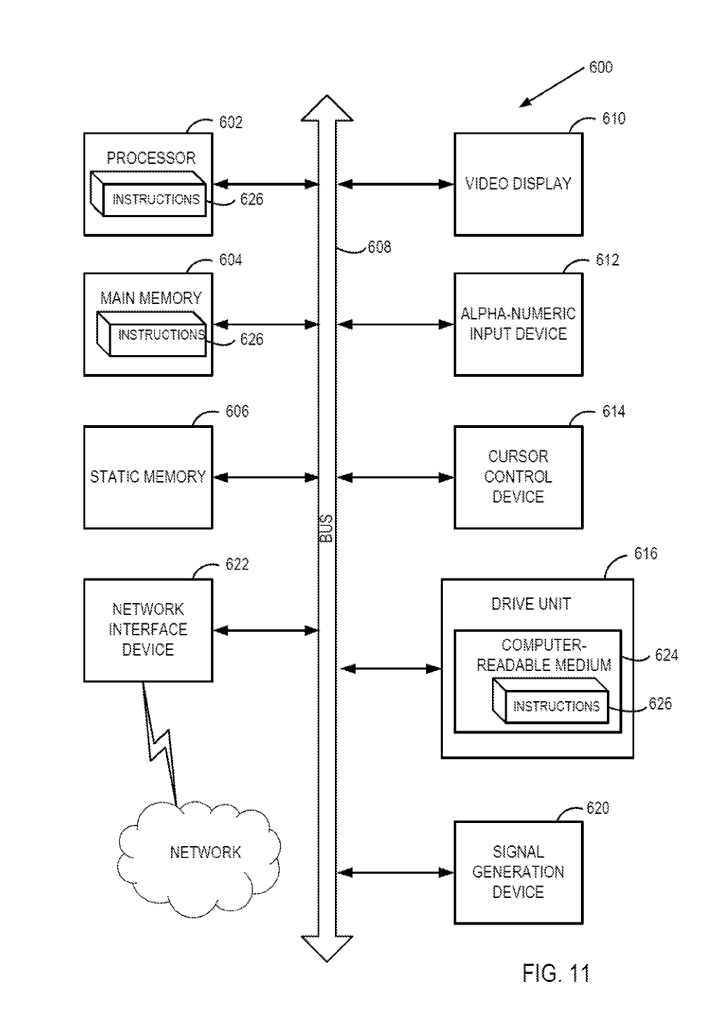

FIG. 11 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a computing device integrated within and/or in communication with a vehicle, a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more processing devices such as an application specific integrated circuit (ASIC), a field programmable gate array (FPGA), a digital signal processor (DSP), network processor, or the like. The processor 602 is configured to execute instructions 626 for performing the operations discussed herein.

The computer system 600 may further include a network interface device 622. The computer system 600 also may include a video display unit 610 (e.g., a touchscreen, liquid crystal display (LCD), or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 (e.g., instructions executed by server machine 120, etc.) embodying any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “providing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. A computer program to activate or configure a computing device accordingly may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The present disclosure is not described with reference to any particular programming language. It will be appreciated that a variety of programming languages may be used to implement the teachings of the disclosure as described herein.

As used herein, the phrase “for example,” “such as,” “for instance,” and variants thereof describe non-limiting embodiments of the presently disclosed subject matter. Reference in the specification to “one case,” “some cases,” “other cases,” or variants thereof means that a particular feature, structure or characteristic described in connection with the embodiment(s) is included in at least one embodiment of the presently disclosed subject matter. Thus the appearance of the phrase “one case,” “some cases,” “other cases,” or variants thereof does not necessarily refer to the same embodiment(s).

Certain features which, for clarity, are described in this specification in the context of separate embodiments, may also be provided in combination in a single embodiment. Conversely, various features which are described in the context of a single embodiment, may also be provided in multiple embodiments separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

What is claimed is:

1. A system comprising:
at least one processor configured to:
receive at least one image;
process the at least one image to identify (a) information corresponding to a hand gesture performed by a user and (b) information corresponding to a surface; and
display content associated with the identified hand gesture in relation to the surface.

2. The system of claim 1, wherein to process the at least one image the at least one processor is further configured to identify information corresponding to an eye gaze of the user.

3. The system of claim 2, wherein to process the at least one image the at least one processor is further configured to identify information corresponding to a pupil of the eye of the user in relation to one or more areas of a face of the user.

4. The system of claim 2, wherein the surface comprises a display and wherein the at least one processor is further configured to define a first region of the display based on the eye gaze.

5. The system of claim 4, wherein to display content the at least one processor is further configured to position a cursor within the first region based on the hand gesture.

6. The system of claim 4, wherein the at least one processor is further configured to:
define a second region of the display based on a change in the eye gaze; and
wherein to display content the at least one processor is further configured to position the cursor within the second region.

7. The system of claim 2, wherein to process the at least one image the at least one processor is further configured to determine a viewing ray with respect to the eye of the user and the surface.

8. The system of claim 7, wherein the surface comprises a display device.

9. The system of claim 7, wherein to display content the at least one processor is further configured to display content associated with the identified hand gesture, the identified voice command, and the determined viewing ray.

10. The system of claim 2, wherein to process the at least one image the at least one processor is further configured to define within the at least one image a first region in relation to the user.

11. The system of claim 10, wherein to process the at least one image the at least one processor is further configured to identify a presence of a pointing element within the first region and wherein to display content the at least one processor is further configured to display a cursor on the surface at a location that corresponds to the presence of the pointing element within the first region.

12. The system of claim 10, wherein to define a first region the at least one processor is further configured to define a second region within the first region.

13. The system of claim 12, wherein to process the at least one image the at least one processor is further configured to identify a presence of a pointing element within the second region and wherein to display content the at least one processor is further configured to adjust movement of a cursor on the surface at a location that corresponds to the presence of the pointing element within the second region.

14. The system of claim 10, wherein the first region corresponds to a first interface displayed on the surface and wherein to process the at least one image the at least one processor is further configured to identify the hand gesture within the first region and wherein to display content the at least one processor is further configured to provide an instruction corresponding the hand gesture with respect to the first interface.

15. The system of claim 14, wherein to define a first region the at least one processor is further configured to define a second region, the second region corresponding to a second interface displayed on the surface and wherein to process the at least one image the at least one processor is further configured to identify the hand gesture within the second region and wherein to display content the at least one processor is further configured to provide an instruction corresponding the hand gesture with respect to the second interface.

16. The system of claim 1, wherein to identify information corresponding to a surface the at least one processor is further configured to identify, in the at least one image, a surface associated with the identified hand gesture; and wherein to display content the at least one processor is further configured to display the content associated with the identified hand gesture in relation to the identified surface.

17. The system of claim 1, wherein the at least one processor is further configured to identify one or more characteristics of the surface.

18. The system of claim 17, wherein to display the visual content is to display the content in relation to the surface based on the one or more characteristics of the surface.

19. The system of claim 17, wherein the at least one processor is further configured to format the content based on the one or more characteristics of the surface.

20. The system of claim 1, wherein the at least one processor is further configured to retrieve the content.

21. The system of claim 1, wherein the at least one processor is further configured to activate an illumination device in relation to the hand.

22. The system of claim 21, the at least one processor is further configured to adjust one or more settings associated with the illumination device are based on the identified hand gesture.

23. The system of claim 1, wherein the at least one processor is further configured to:
receive one or more audio inputs; and
process the one or more audio inputs to identify a command.

24. The system of claim 23, wherein to display content the at least one processor is further configured to display content associated with the identified hand gesture and the identified command in relation to the surface.

25. A non-transitory computer-readable medium having instructions encoded thereon that, when executed by a processing device, cause the processing device to:
receive at least one image;
process the at least one image to identify (a) information corresponding to a hand gesture performed by a user and (b) information corresponding to a surface; and
display content associated with the identified hand gesture in relation to the surface

26. A system comprising:
at least one processor configured to:
receive at least one image;
receive one or more audio inputs;
process the at least one image to identify (a) information corresponding to a line of sight of a user directed towards a device and (b) information corresponding to a hand gesture of the user directed towards a location;
process the one or more audio inputs to identify a command; and
provide to the device, one or more instructions corresponding to the identified command in relation to the location.
